(19) United States
(12) Patent Application Publication
(10) Pub. No.: US 2019/0174368 A1
(43) Pub. Date: Jun. 6, 2019

(54) SECURITY HANDLING FOR NETWORK SLICES IN CELLULAR NETWORKS

(71) Applicant: Nokia Technologies Oy, Espoo (FI)

(72) Inventors: Guillaume DECARREAU, Munich (DE); Andreas MAEDER, Wuerzburg (DE)

(21) Appl. No.: 16/319,784

(22) PCT Filed: Jul. 22, 2016
(86) PCT No.: PCT/US2016/043668

§ 371 Date: Jan. 22, 2019

(51) Int. Cl. H04W 36/00; H04W 36/08; H04W 12/00; H04W 80/08; H04W 80/02; H04W 36/24; H04W 76/12; H04W 24/10

(52) U.S. Cl. CPC H04W 36/0038; H04W 36/08; H04W 12/0017; H04W 24/10; H04W 80/02; H04W 36/24; H04W 76/12; H04W 80/08

(57) ABSTRACT

Methods and apparatus, including computer program products, are provided for mobility. In some example embodiments, there may be provided a method that includes determining whether to handover to a target base station, the determining based on whether a security level of the target base station satisfies a security threshold; enabling a relocation of a packet data convergence protocol entity to enable ciphering a tunnel to a user equipment, when the security level satisfies the security threshold; and inhibiting the relocation of the packet data convergence protocol entity to inhibit ciphering a tunnel to the user equipment, when the security level does not satisfy the security threshold. Related systems, methods, and articles of manufacture are also described.

### FIELD

The subject matter described herein relates wireless mobility.

### BACKGROUND

As the next generation of cellular wireless evolves, deployments in 5G may see a variety of wireless deployments. In addition to cellular and smart phones, consumer electronics, home automation, smart sensors/internet of things, transportation, and the like may all use the 5G network in different ways and have different requirements. Moreover, the network may include macro base stations with small cell base stations deployed within those macro base stations. In view of this 5G evolution, network slices may be used. The phrase “network slice” refers to a logical, or virtual, network layered on the cellular network. Network slices may provide multiple, independent, and dedicated logical end-to-end networks that may be created within a given network infrastructure to run services which may have different requirements with respect to latency, reliability, throughput, mobility, and/or the like. For example, a network slice may provide a dedicated, logical end-to-end network for a car manufacturer to enable communications with its cars, or may provide a dedicated, logical end-to-end network for the car manufacturer to communicate with interne of things (IoT) devices used in a manufacturing facility during a manufacturing process. The network slice may be setup and operated by an administrator, such as a service provider, although other entities may setup the network slice as well.

### SUMMARY

Methods and apparatus, including computer program products, are provided for mobility.

In some example embodiments, there may be provided a method that includes determining whether to handover to a target base station, the determining based on whether a security level of the target base station satisfies a security threshold; enabling a relocation of a packet data convergence protocol entity to enable ciphering a tunnel to a user equipment, when the security level satisfies the security threshold; and inhibiting the relocation of the packet data convergence protocol entity to inhibit ciphering a tunnel to the user equipment, when the security level does not satisfy the security threshold.

In some variations, one or more of the features disclosed herein including the following features can optionally be included in any feasible combination. The relocated packet data convergence protocol entity may enable the establishment of a secure session to the user equipment and/or a secure connection to the user equipment by at least enabling the relocation of ciphering information to the target base station. The inhibiting may further include relocating, to the target base station, at least a radio link protocol, a media access control protocol, and/or a radio link control protocol. The inhibiting may further include relocating, to a third node, at least the packet data convergence protocol entity, wherein the third node satisfies the security threshold and relocating, to the target base station, at least a radio link protocol, a media access control protocol, and/or a radio link control protocol. The third node may include a third base station and/or a secure node implemented in a network. The determining may be performed in response to receiving a measurement report from the user equipment. The security of at least one neighboring base station including the target base station may be received. The security threshold may be specific to a network slice to the user equipment and/or predetermined for a plurality of base stations including the target base station. The security level of the at least one neighboring base station may be received via a broadcast, received from a core network node, and/or received during an instantiation of a network slice to the user equipment. The security level may be obtained from subscription information for a network slice to the user equipment.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIGS. 1A-1B depicts an example of the PDCP not being relocated during a handover, in accordance with some example embodiments;

FIG. 2 depicts a signaling diagram for providing a base station with neighboring base station security information, in accordance with some example embodiments;

FIG. 3 depicts a signaling diagram for relocating the PDCP to a target base station, when the target base station is able to meet certain security requirements, in accordance with some example embodiments;

FIGS. 4A-4B depicts an example of the PDCP being relocated during a handover, in accordance with some example embodiments;

FIG. 5A depicts a signaling diagram showing the PDCP not being relocated to the target base station, when the target base station is not able to meet the security requirements, in accordance with some example embodiments;

FIG. 5B depicts the PDCP remaining at the source base station while the lower layer protocols are relocated to the target base station, in accordance with some example embodiments;

FIG. 6A-6B depict the target base station before and after a handover in which the PDCP is not relocated to the target base station but the radio link is relocated, when the target base station is not able to meet the security requirements, in accordance with some example embodiments;

FIG. 7 depicts a signaling diagram showing the PDCP being relocated to a third node rather than the target base station, when the target base station is not able to meet the security requirements, in accordance with some example embodiments;

FIG. 8A-8B depict the target base station before and after a handover in which the PDCP is not relocated to the target base station but the radio link is relocated to the target base station while the PDCP is relocated to a third node, when the target base station is not able to meet the security requirements, in accordance with some example embodiments;

FIG. 9 depicts an example system including a service node to provide a secure node for PDCP relocation during a handover when the target base station cannot satisfy the security level needed for a network slice, in accordance with some example embodiments;

FIG. 10 depicts an example of an over-the-top tunnel via a ciphering entity, in accordance with some example embodiments; and

FIG. 11 depicts an example of an apparatus, in accordance with some example embodiments.

Like labels are used to refer to same or similar items in the drawings.

### DETAILED DESCRIPTION

In some example embodiments, cryptographic isolation may be provided between network slices in networks, such as 5G and/or other types of networks, and, more particularly, the interaction of the network slices, security, and radio access network.

Network slices may carry sensitive or confidential information, in which case the network slice may need to be isolated and independent from other network slices used by other entities, such as tenants sharing a portion of the infrastructure (for example, cloud, network, radio access network, and/or the like). Moreover, different network slices may have different security requirements according to the use case for which the network slice is instantiated. This can range from use cases such as mobile broadband (in which conventional security requirements may be sufficient) to use cases in industrial and sensitive areas (in which very strict requirements on physical security as well as integrity and ciphering may be implemented). To illustrate further, fixed networks and wireless network equipment, such as macro and small cell base stations) may be exposed to different types of security threats, often depending on for example the physical deployment environment. Moreover, wireless network equipment in, or under the control of, network operator premises may be generally considered secure (depending on for example the level of physical security at the premises to prevent tampering with the wireless network equipment). However, wireless network equipment installed outdoors (for example, on a roof or on a mast) and/or beyond physical/perimeter security may be considered more vulnerable to tampering and security threats. These differences in the security level of devices may be seen in other devices/nodes and/or lower-layer wireless functions as well. Moreover, these differences may be seen more frequently with the proliferation of small cells, which may be installed in locations with little physical security as well as locations without or outside safeguards to prevent tampering. As such, different nodes of a mobile network may have different levels of security.

In some cases, the security requirements may prohibit the use of certain network nodes that are vulnerable and thus under a possible threat of tampering. This may mean that in practice certain devices or network nodes cannot be used by a user equipment, such as a cellular phone, smart phone, tablet, and/or other wireless device. In the case of evolved Node B (eNB) type base stations for example, security related functions such as ciphering and integrity protection in the packet data convergence (PDCP) layer may not be used in a base station having a relatively low security level (for example, vulnerable to tampering, outside a protected physical security area, and/or the like). The PDCP protocol may be specified by standard, such as TS 25.323 and/or TS 36.323. PDCP may provide, as part of the control plane and/or user plane, services such as ciphering and integrity protection between for example a network node (for example, a base station) and a user equipment (over for example the Uu interface).

When there is a handover, the PDCP layer of a radio bearer may need to be relocated to a target base station. However, if the target base station cannot satisfy a certain level of security, then in accordance with some example embodiments, the PDCP layer (or portion thereof) may not be relocated to the target base station.

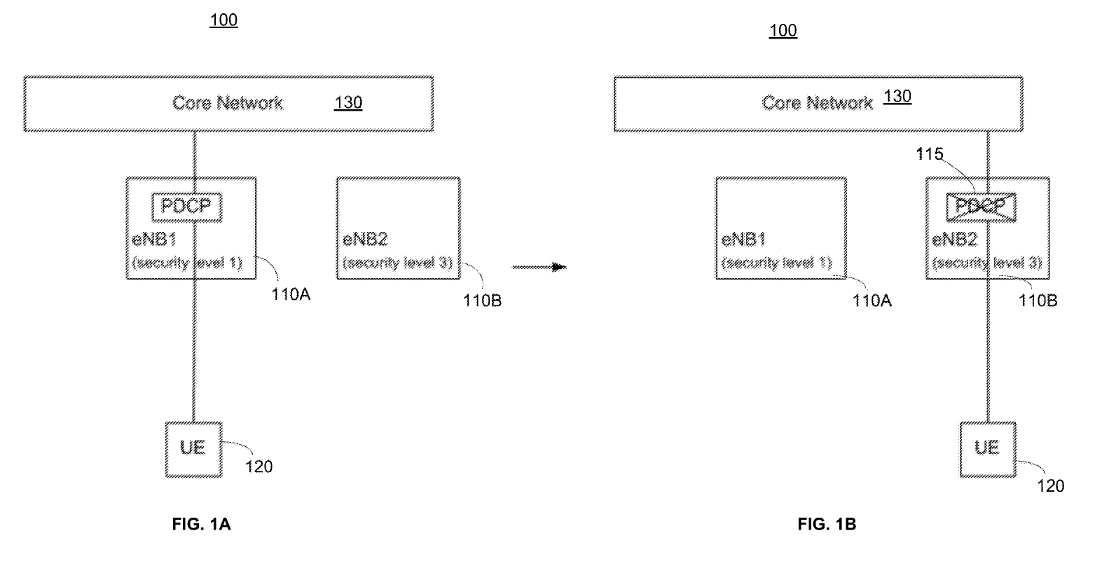

FIG. 1A depicts an example system 100 including a user equipment 120, such as a cellular phone, a smart phone, and/or other wireless device, coupled to a source base station (labeled eNB1) 110A and the core network 130. The user equipment 120 may send a measurement report to base station 110A indicating that a handover might be needed to a target base station (labeled eNB2) 110B. While the source base station 110A may satisfy the security requirements of the network slice (as shown for example by “security level 1”), the target base station 110B may not be able to satisfy the security requirements of the network slice as the network slice in the example requires security level 1 and the target base station 110B cannot satisfy the security level with a lower “security level 3.” As such, the PDCP layer (of the data radio bearer managed by the network slice) may not be relocated to the second base station 110B as shown at FIG. 1B at 115 (showing crossbars across the PDCP).

Although some of the examples herein refer to eNB type base stations, other types of base stations, including 5G base stations, femtocell base stations, home eNB base station, picocell base station, and/or other wireless access points may be used as well. Moreover, although some of the examples refer to relocating security (for example, ciphering and/or integrity protection) as part of the PDCP protocol, protocols other than PDCP may be used as well. Furthermore, although some of the examples herein refer to network slices, the examples described herein may be utilized in connection with other services that do not implement network slices as well.

In some example embodiments, the base station, such as an eNB type base station, including the radio resource control function may be aware of the security level of the neighboring base stations. As such, when a user equipment moves and needs to perform handover between from a source base station to a target base station, the network may, in some example embodiments, check whether the PDCP (or portion thereof) can be relocated to the target base station (for example, by determining whether the target base station can fulfill the requirements in term of security).

In some example embodiments, if the target base station can fulfill the security requirements, the PDCP layer, or portion thereof, may be relocated to the target location

In some example embodiments, if the target base station cannot fulfill the security requirements, the PDCP layer stays in its current location. However, some if not all of the sublayers below PDCP in the radio protocol stack may, in accordance with some example embodiments, be relocated to the target base station.

In some example embodiments, if the target base station cannot fulfill the security requirements, the PDCP layer may be relocated to another, third network node (for example, a third base station) that fulfills the security requirements while portions of the lower layers may be relocated to the target base station.

In some example embodiments, if the target base station cannot fulfill the security requirements, a specific network node (for example, a virtualized network entity in a cloud-computing environment) may be implemented so that the network node has sufficient security so that the ciphering associated with the PDCP may be relocated to that specific network node. For example, the network node may be implemented in a secure area, and may include the PDCP protocol layer and/or other functions, such as a control plane function. Alternatively or additionally, the network node may be implemented securely in the network, such as a cloud, in a virtual machine configured to provide the PDCP protocol layer and/or other functions, such as a control plane function. Alternatively or additionally, the network node may include the PDCP protocol layer and/or certain lower other functions, such as the ability to connect to the core network and/or other neighboring base stations but not the ability to control radio.

In some example embodiments, an over-the-top tunnel may be established on-demand between a secure network entity in the radio access network (for example, in a secure edge cloud) and the user equipment, when a handover is requested towards a target base station that cannot fulfill the security requirements. This tunnel may be closed when the user equipment moves again into the coverage of a base station that can fulfill the security requirements. The tunnel end-point on the network side may be logically located between the radio access network-core network interface and the PDCP layer. In this case, a secure tunnel may be established between a tunnel protocol client located in a secure cloud node and the UE over-the-top (for example, above the radio protocol stack). The ciphering function in the secure cloud node may be triggered when there is a handover to a base station with an insufficient security level. At the UE, the UE may need to include tunnel protocol client software (for example, as an application), which may be configured to be available for a tunnel establishment procedure.

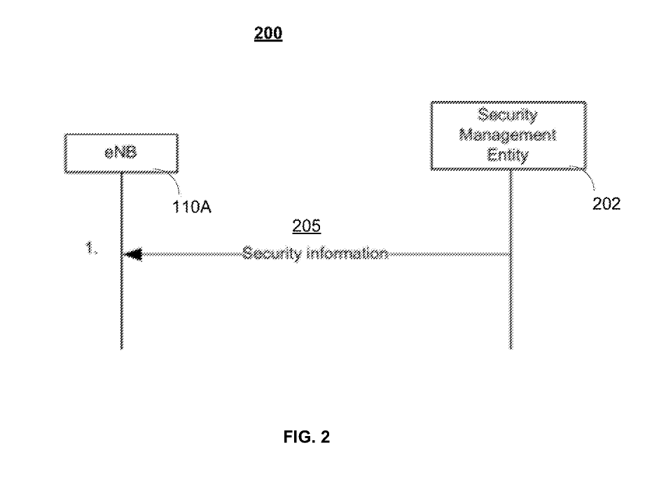

FIG. 2 depicts a signaling diagram 200, in accordance with some example embodiments. In the example of FIG. 2, a base station, such as base station 110A, may receive, at 205, security information from a security management entity 202. This security information may make the radio access network including the base station 110A aware of the security level of at least one neighboring base station. To illustrate further, the security information may include an identifier, such as a cell identifier, for a neighboring base station and a corresponding indication of the security level established for that base station. At 205, the security information may be broadcast to one or more base stations including base station 110A or signaled between the security management entity 202 and one or more base stations. The security management entity 202 may be implemented as part of the operation and management (OAM) function or system. Alternatively or additionally, the security management entity 202 may be implemented as part of the network slice instantiation procedure and signaled from a core network entity.

Table 1 below shows an example of security information for a plurality of base stations. In the example of Table 1, the security level is based on a relative scale, wherein level 3 may be the lowest or least secure, while level 0 may be considered the most secure (for example, the base station is located in a secure or controlled location). Although Table 1 provides an example of security information for neighboring base stations, other schemes may be used to indicate the security level of the base stations.

TABLE 1

| Cell or Access Point ID | Security Level |
|---|---|
| eNB#1 | security level 0 |
| eNB#2 | security level 0 |
| eNB#3 | security level 1 |
| eNB#4 | security level 3 |
| eNB#5 | security level 2 |

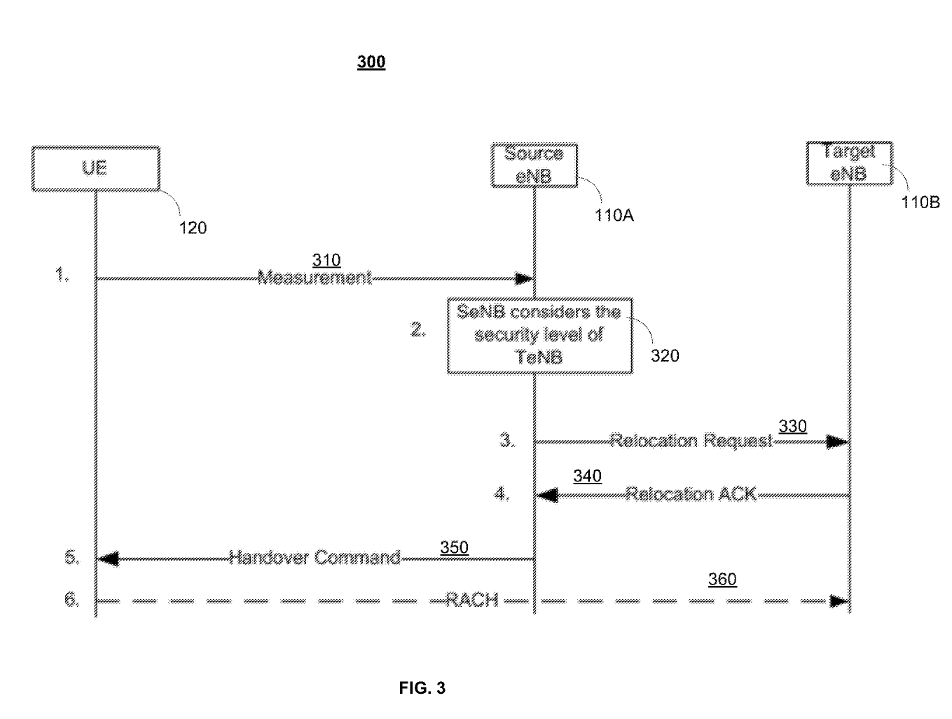

FIG. 3 depicts a signaling diagram 300, in accordance with some example embodiments. The example embodiment of FIG. 3 depicts the PDCP being relocated to a target base station, when the target base station is able to meet the security requirements.

At 310, the user equipment 120 may report one or more radio measurements to the source base station 110A, in accordance with some example embodiments. The radio measurements may indicate that a handover may be desirable or needed to a target cell being served by the target base station 110B. The target base station may be implemented as a small cell base station, although other types of base stations and wireless access points may be used as well. Furthermore, the radio measurement reporting may be event driven, such as A3 (for example, neighboring cell becomes better than the serving cell by an offset), although other events may trigger the report.

At 320, the source base station 110A may check the security level of the target base station 110B to determine whether the target base station's security level satisfies a certain security level, in accordance with some example embodiments. The source base station 110A may have information indicating the security level of one or more neighboring nodes including target base station 110B. Moreover, the source base station 110A may determine that the target base station 110B satisfies or can fulfill the security level needed. The source base station may obtain this information as noted above with respect to FIG. 2. In some implementations, the base stations may use a common or absolute security level system. The source base station may also have a mapping between a given network slice and the required security level. For example, the source base station may have a mapping that indicates network slice X to UE 120 needs at least security level 3. As such, the source base station can determine, based on neighboring base station security level and the needed security level, whether a neighboring base station is secure enough for relocating the PDCP. In some implementations, the security level needed for a given network slice may be stored in subscription information for a given UE 120. Alternatively or additionally, the security level may also be a per-slice parameter (for example, the security level would be the same for all UEs in a certain network slice).

In accordance with some example embodiments, the source base station 110A may request, at 330, relocation to the target base station 110B of the PDCP including security information and lower layer information (for example, radio bearer information), when the check at 320 determines the target base station 110B can satisfy the security requirements for user equipment 120.

At 340, the target base station 110B may send an acknowledgement message back to the source base station 110A, in accordance with some example embodiments. At 350, the source base station 110A may send the handover message to the user equipment suggesting or commanding the handover to the target base station 110B, in accordance with some example embodiments. In response to the message 350, the user equipment may, at 360, perform a random access procedure by accessing a random access channel (RACH) to the target base station 110B to complete the handover, in accordance with some example embodiments.

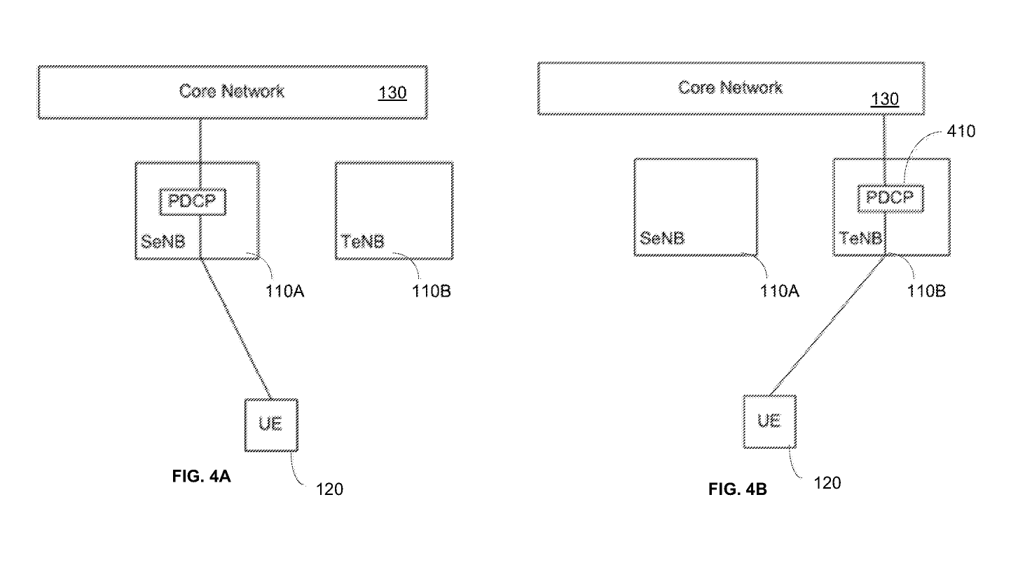

FIG. 4A depicts the source base station 110A including the PDCP, and FIG. 4B depicts the PDCP at the target base station 110B after the handover when the target base station can fulfill certain security requirements, in accordance with some example embodiments. In the example of FIG. 4B, a PDCP entity may be relocated to the target base station 110B, and the PDCP entity may represent a protocol or code that enables the relocation of a secure session or a secure connection (for example, over a ciphered tunnel) to the user equipment (where another PDCP entity may de-cipher the session or tunnel).

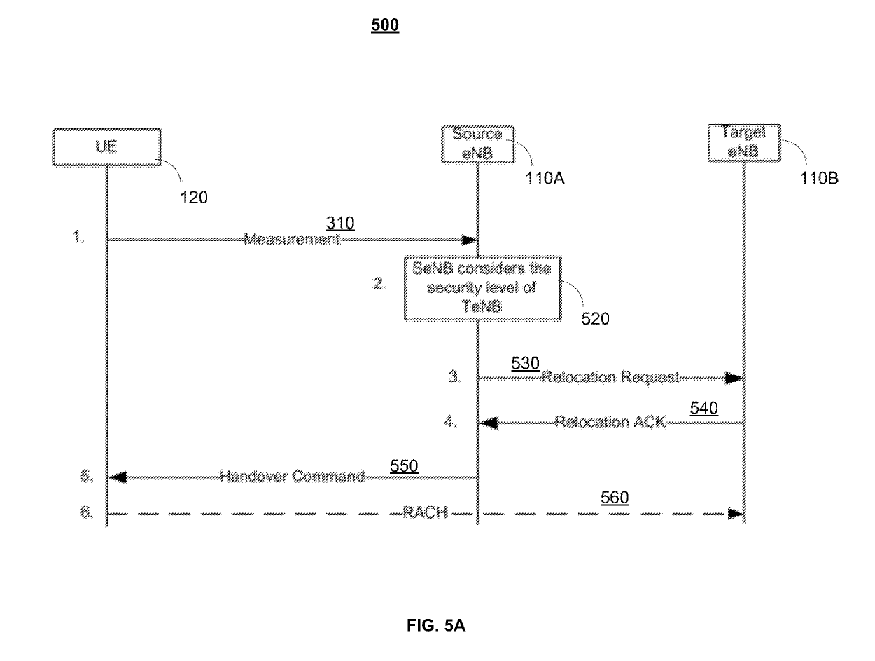

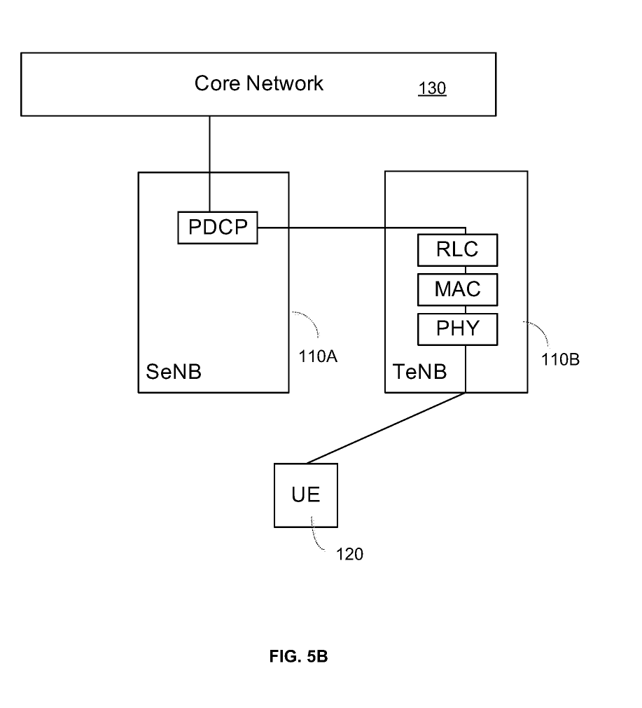

FIG. 5A depicts a signaling diagram 500, in accordance with some example embodiments. The example embodiment of FIG. 5A depicts the PDCP not being relocated to the target base station 110B, when the target base station is not able to meet the security requirements.

In some example embodiments, the user equipment 120 may, at 310, report one or more radio measurements to the source base station 110A, as described above with respect to FIG. 3.

At 520, the source base station 110A may check the security level of the target base station 110B to determine whether the target base station's security level satisfies the security requirements for a given network slice, in accordance with some example embodiments. The source base station 110A may have information indicating the security level of one or more neighboring nodes including target base station 110B (which may be obtained as noted above with respect to FIG. 2). In some example embodiments, the source base station 110A may determine that the target base station 110B cannot satisfy the security level needed.

When the check at 520 determines the target base station 110B cannot satisfy the security requirements for user equipment 120, the source base station may, at 530, request the relocation of the lower layers (for example, physical layer, media access control, radio link control, radio bearers, and/or the like) to target base station 110B, but not the relocation of security information such as PDCP security (for example, ciphering or integrity protection) which may remain at the source base station 110A.

FIG. 5A depicts the PDCP remain at the source base station 110A, while the lower layer protocols, such as the physical (PHY) layer, media access control (MAC) layer, and/or radio link control (RLC) layer, being relocated to the target base station 110B.

At 540, the target base station 110B may send an acknowledgement message back to the source base station 110A, in accordance with some example embodiments. At 550, the source base station 110A may send a handover message to the user equipment suggesting or commanding the handover to the target base station 110B, in accordance with some example embodiments. In response to the message 550, the user equipment may, at 560, perform a random access procedure by accessing a random access channel (RACH) to the target base station 110B to complete the handover, in accordance with some example embodiments.

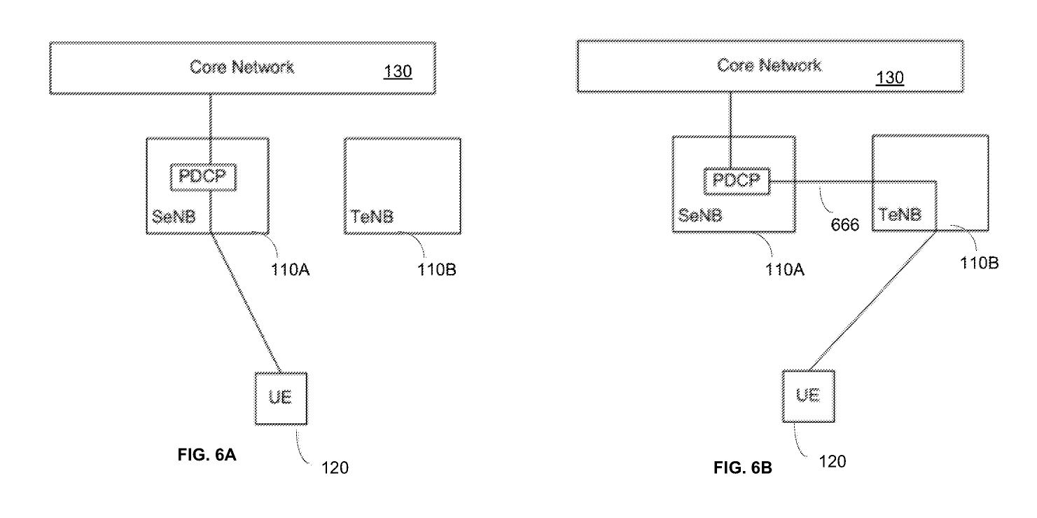

FIG. 6A depicts the source base station 110A including the PDCP before the handover, while FIG. 6B depicts the UE after the handover to target base station 110B. At FIG. 6B, encrypted PDCP packet data units (PDUs) are forwarded at 666 to the target base station 110B, which forwards the encrypted PDU to the lower layers and the user equipment 120. The configuration of FIG. 6B may be implemented in accordance with for example Alternative 2C as described in 3GPP TS 36.842, although other implementation may be used as well.

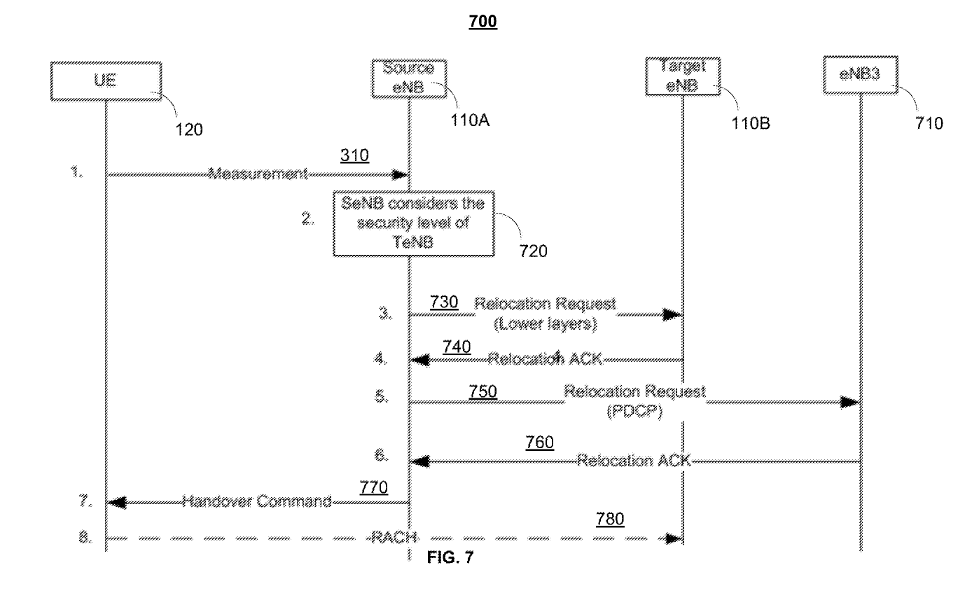

FIG. 7 depicts a signaling diagram 700, in accordance with some example embodiments. When the target base station is not able to meet the security requirements, the example embodiment of FIG. 7 depicts the PDCP being relocated to another network node such as a third base station rather than relocating the PDCP to the target base station 110B.

In accordance with some example embodiments, the user equipment 120 may report, at 310, one or more radio measurements to the source base station 110A, as described above with respect to FIG. 3.

At 720, the source base station 110A may check the security level of the target base station 110B to determine whether the target base station's security level satisfies the security requirements for the given network slice, in accordance with some example embodiments. The source base station 110A may have information indicating the security level of one or more neighboring nodes including target base station 110B (which may be obtained as noted above with respect to FIG. 2). In some example embodiments, the source base station 110A may determine that the target base station 110B cannot satisfy the security level needed. However, the source base station 110A may determine that a third network node, such as a third base station 710 can satisfy the security requirements.

When the check at 720 determines the target base station 110B cannot satisfy the security requirements for user equipment 120, the source base station may request, at 730, the relocation of the lower layers (for example, physical layer, media access control, radio link control, radio bearers, and/or the like) to target base station 110B, but not the relocation of ciphering or other security information such as PDCP security information to enable tunneling, in accordance with some example embodiments.

At 740, the target base station 110B may send an acknowledgement message back to the source base station 110A, in accordance with some example embodiments. At 750, the source base station 110A may request the relocation of PDCP to the third base station 710, in accordance with some example embodiments. In response, the third base station 710 may, in accordance with some example embodiments, send an acknowledgement at 760. At 770, the source base station 110A may send the handover message to the user equipment suggesting or commanding the handover to the target base station 110B, in accordance with some example embodiments. In response to the message 770, the user equipment may, at 780, perform a random access procedure by accessing a random access channel (RACH) to the target base station 110B to complete the handover to the target base station 110B, in accordance with some example embodiments.

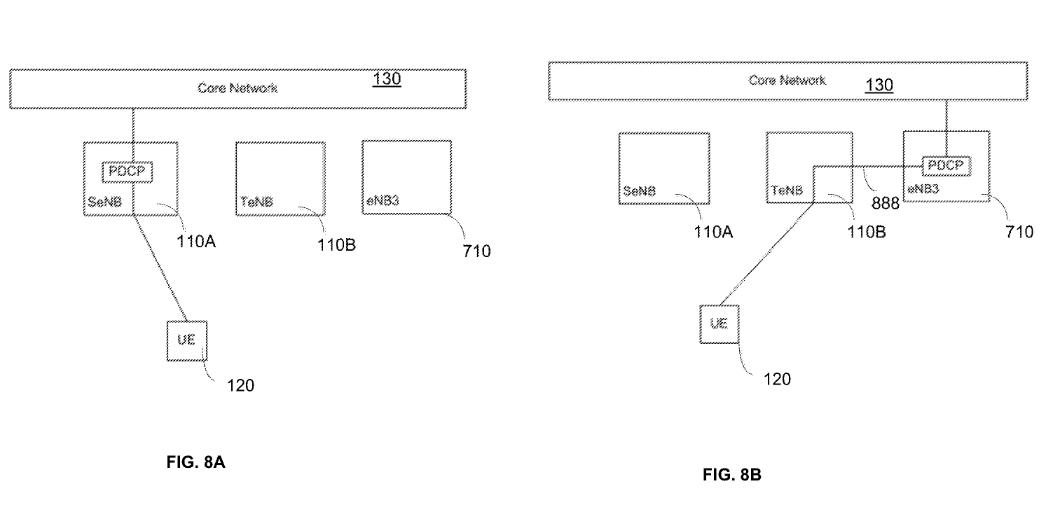

FIG. 8A depicts the source base station 110A including the PDCP before the handover, while FIG. 8B depicts the state after the handover to target base station 110B including the security aspects of the PDCP (for example, ciphering and/or integrity protection) being located at the third base station 710 as shown at FIG. 8B. At FIG. 8B, encrypted PDCP PDUs may be forwarded at 888 to the target base station 110B, which forwards the encrypted PDUs to the lower layers and the user equipment 120.

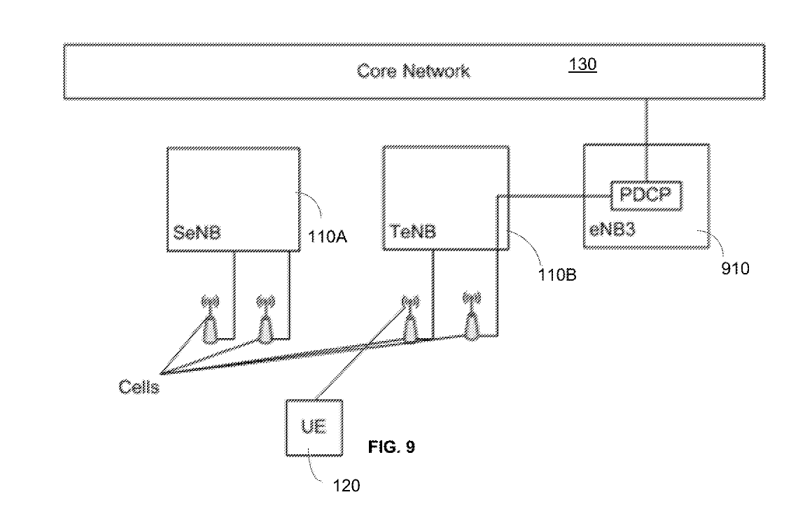

FIG. 9 depicts an example system 900, in accordance with some example embodiments. Rather than use a fully functional third base station 710, the base station 910 may be implemented as a service node with a PDCP function and minimal control plane functions, as well as the ability to connect to the core network 130 and neighboring base stations such as base station 110B. This entity 910 may fulfill the security requirements of the network slice. However, this entity 910 may not be configured to control any radio cells at the source base station 110A or target base station 110B. Moreover, the entity 910 may not directly possess physical, media access control, and/or radio link control layers. Alternatively or additionally, this entity 910 may be instantiated on demand on specific hardware, which may be hardened against security threats.

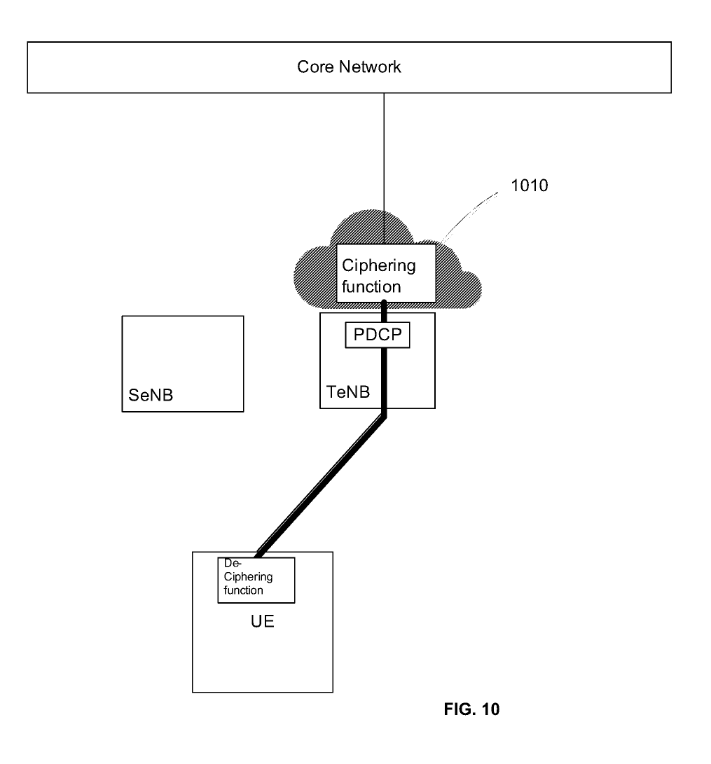

FIG. 10 depicts an example of an over-the-top tunnel via a ciphering entity 1010, in accordance with some example embodiments. The over-the-top tunnel may be established on-demand between a secure network entity the radio access network (for example, in a secure edge cloud) and the user equipment, when a handover is requested towards a target base station, which may not be able to fulfill security requirements. The data from the core network may be ciphered in a secure network entity before being treated in the target base station. There may be a corresponding entity at the UE to de-cipher the data. The ciphered data may be handled in the target base station (for example, the PDPCP and lower layers) as if it came from the core network. The ciphered data may then be deciphered in the UE. The tunnel may be closed as soon as the user equipment moves into the coverage of base station with sufficient security. The tunnel end-point on the network side may be logically located between the RAN-CN interface and the PDCP layer.

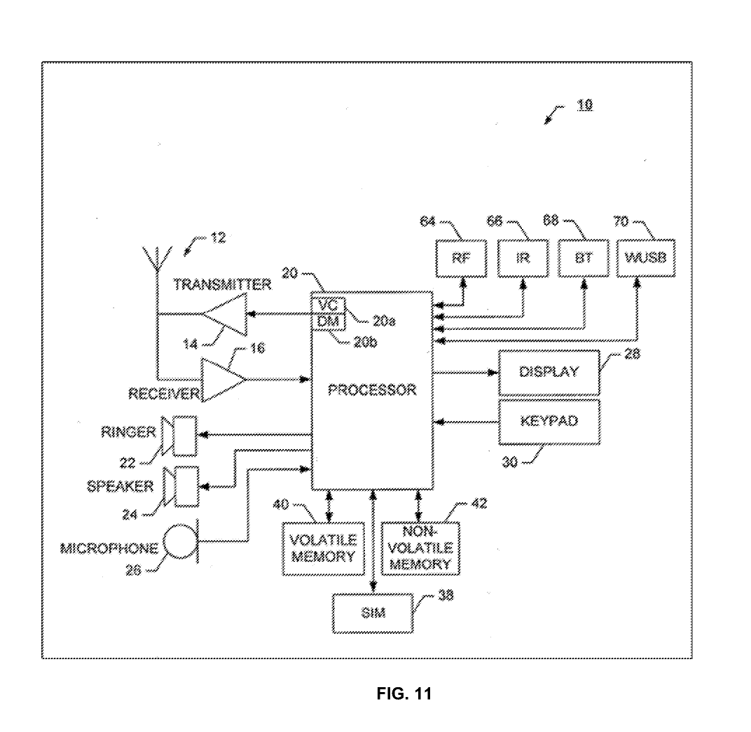

FIG. 11 illustrates a block diagram of an apparatus 10, in accordance with some example embodiments. The apparatus 10 (or portions thereof) may be configured to provide a radio, such as user equipment (for example, user equipment 120) and/or a base station (for example, base station 110A-B). The apparatus may be implemented as any device including a wireless device, a smart phone, a cell phone, a machine type communication device, a wireless sensor, a radio relay, an access point, and/or any other radio including a processor and memory based device.

The apparatus 10 may include at least one antenna 12 in communication with a transmitter 14 and a receiver 16. Alternatively transmit and receive antennas may be separate. The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 4 as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, and/or the like. In addition, these signals may include speech data, user generated data, user requested data, and/or the like.

The apparatus 10 may be capable of operating with one or more air interface standards, communication protocols, modulation types, access types, and/or the like. For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced, 5G, and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 11, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), an eUICC, an UICC, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing operations disclosed herein with respect to a user equipment and/or a base station. The memories may comprise an identifier, such as an international mobile equipment identification (IMEI) code, capable of uniquely identifying apparatus 10. The memories may comprise an identifier, such as an international mobile equipment identification (IMEI) code, capable of uniquely identifying apparatus 10. In the example embodiment, the processor 20 may be configured using computer code stored at memory 40 and/or 42 to control and/or provide one or more aspects disclosed herein with respect to the user equipment and/or a base station (see, for example, process 200, 300, 500, 700, and/or the like as disclosed herein).

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 11, computer-readable medium may comprise a non-transitory computer-readable storage medium that may be any media that can contain or store the instructions for use by or in connection with an instruction execution system, apparatus, or device, such as a computer.

Without in any way limiting the scope, interpretation, or application of the claims appearing below, a technical effect of one or more of the example embodiments disclosed herein is more secure handovers.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

1-20. (canceled)

21. An apparatus comprising:
at least one processor; and
at least one memory including computer program code, the at least one memory and the computer program code configured to, with the at least one processor, cause the apparatus to at least:
determine, by the apparatus, whether to handover a user equipment to a target base station, the determination based on whether a security level of the target base station satisfies a security threshold;
enable, when the security level satisfies the security threshold, a relocation of a packet data convergence protocol entity to enable ciphering of a tunnel to the user equipment; and
inhibit, when the security level does not satisfy the security threshold, the relocation of the packet data convergence protocol entity to inhibit ciphering of a tunnel to the user equipment.

22. The apparatus of claim 21, wherein the relocation of the packet data convergence protocol entity enables an establishment of a secure session to the user equipment, and/or enables an establishment of a secure connection to the user equipment by at least enabling a relocation of ciphering information to the target base station.

23. The apparatus of claim 21, wherein to inhibit the relocation of the packet data convergence protocol entity, the at least one memory and the computer program code are further configured to, with the at least one processor, cause the apparatus to at least:
relocate, to the target base station, a radio link protocol, a media access control protocol, and/or a radio link control protocol.

24. The apparatus of claim 21, wherein to inhibit the relocation of the packet data convergence protocol entity, the at least one memory and the computer program code are further configured to, with the at least one processor, cause the apparatus to at least:
relocate, to a third node, at least the packet data convergence protocol entity, wherein the third node satisfies the security threshold; and
relocate, to the target base station, a radio link protocol, a media access control protocol, and/or a radio link control protocol.

25. The apparatus of claim 24, wherein the third node comprises a third base station and/or a secure node implemented in a network.

26. The apparatus of claim 21, wherein the at least one memory and the computer program code are further configured to, with the at least one processor, cause the apparatus to at least determine whether to handover the user equipment to the target base station based on a measurement report received from the user equipment.

27. The apparatus of claim 21, wherein the at least one memory and the computer program code are further configured to, with the at least one processor, cause the apparatus to at least:
receive the security level of at least one neighboring base station including the target base station.

28. The apparatus of claim 21, wherein the security threshold is specific to a network slice, specific to the user equipment, and/or predetermined for a plurality of base stations including the target base station.

29. The apparatus of claim 21, wherein the security level of at least one neighboring base station is received via a broadcast, received from a core network node, and/or received during an instantiation of a network slice.

30. The apparatus of claim 21, wherein the security level for a network slice is obtained from subscription information of the user equipment.

31. A method comprising:
determining, at a source base station, whether to handover a user equipment to a target base station, the determining based on whether a security level of the target base station satisfies a security threshold;
enabling, when the security level satisfies the security threshold, a relocation of a packet data convergence protocol entity to enable ciphering of a tunnel to the user equipment; and
inhibiting, when the security level does not satisfy the security threshold, the relocation of the packet data convergence protocol entity to inhibit ciphering of a tunnel to the user equipment.

32. The method of claim 31, wherein the relocation of the packet data convergence protocol entity enables an establishment of a secure session to the user equipment and/or an establishment of a secure connection to the user equipment by at least enabling the relocation of ciphering information to the target base station.

33. The method of claim 31, wherein the inhibiting further comprises relocating, to the target base station, a radio link protocol, a media access control protocol, and/or a radio link control protocol.

34. The method of claim 31, wherein the inhibiting further comprises:
relocating, to a third node, at least the packet data convergence protocol entity, wherein the third node satisfies the security threshold; and
relocating, to the target base station, a radio link protocol, a media access control protocol, and/or a radio link control protocol.

35. The method of claim 34, wherein the third node comprises a third base station and/or a secure node implemented in a network.

36. The method of claim 31, wherein the determining is performed in response to receiving a measurement report from the user equipment.

37. The method of claim 31, further comprising:
receiving the security level of at least one neighboring base station including the target base station.

38. The method of claim 31, wherein the security threshold is specific to a network slice, specific to the user equipment, and/or predetermined for a plurality of base stations including the target base station.

39. The method of claim 31, wherein the security level of at least one neighboring base station is received via a broadcast, received from a core network node, and/or received during an instantiation of a network slice.

40. A non-transitory computer-readable storage medium including program code which, when executed by at least one processor, causes operations comprising:
determining, at a source base station, whether to handover a user equipment to a target base station, the determining based on whether a security level of the target base station satisfies a security threshold;
enabling, when the security level satisfies the security threshold, a relocation of a packet data convergence protocol entity to enable ciphering of a tunnel to the user equipment; and
inhibiting, when the security level does not satisfy the security threshold, the relocation of the packet data convergence protocol entity to inhibit ciphering of a tunnel to the user equipment.
